(19) United States
(12) Patent Application Publication
(10) Pub. No.: US 2026/0260962 A1
(43) Pub. Date: Sep. 3, 2026

(54) DEVICE FOR THERMALLY CONTROLLING A VEHICLE BATTERY PACK

(71) Applicant: VALEO SYSTEMES THERMIQUES, La Verriere (FR)

(72) Inventors: Julien TISSOT, La Verriere (FR); Kamel AZZOUZ, La Verriere (FR); Julio GUERRA, La Verriere (FR); Moussa NACER-BEY, La Verriere (FR)

(73) Assignee: VALEO SYSTEMES THERMIQUES, La Verriere (FR)

(21) Appl. No.: 18/866,744

(22) PCT Filed: May 9, 2023
(86) PCT No.: PCT/EP2023/062181

§ 371 Date: Nov. 18, 2024

(30) Foreign Application Priority Data
May 16, 2022 (FR) 2204640

(51) Int. Cl. H01M 10/6557; H01M 10/613; H01M 10/625; H01M 10/647; H01M 10/6568; H01M 50/209; H01M 50/24; H01M 50/249; H01M 50/271

(52) U.S. Cl. CPC H01M 10/6557; H01M 10/613; H01M 10/625; H01M 10/647; H01M 10/6568; H01M 50/209; H01M 50/24; H01M 50/249; H01M 50/271

(57) ABSTRACT

The invention relates to a device for the thermal regulation of a vehicle battery pack, which includes: a housing including a circuit for circulating heat-transfer fluid, which housing is suitable for housing the pack, which pack includes at least two battery cells each having two large lateral faces, which cells are adjacent at one of their large lateral faces; a spacer installed between the cells and configured to contact the adjacent large lateral faces of the cells; the spacer includes: a perforated part situated opposite the large adjacent lateral faces and extending over most of the large faces; one or more ribs extending in the perforated part, the rib or ribs being arranged so as to form at least one forced-circulation circuit for the circulation of the heat-transfer fluid between the cells.

### TECHNICAL FIELD

The invention relates to a device for the thermal regulation of a vehicle battery pack and to a cooling system comprising such a device. The invention also relates to a motor vehicle equipped with this cooling system.

The invention relates in particular to the technical field of the thermal regulation of electrical energy storage elements, in particular battery elements, liable to release heat during their operation. The invention applies preferentially, but not exclusively, to the automotive field and more particularly to the field of electric and/or hybrid powered vehicles.

### BACKGROUND OF THE INVENTION

The electrical energy of electric and/or hybrid powered vehicles is supplied by one or more battery packs, each of which comprises several battery cells. During their operation, the cells are caused to heat and swell, thus risking becoming damaged. In particular, one charging technique, called fast charging, consists in charging the cells at a high voltage and a high amperage, in a short time, in particular in a maximum time of about twenty minutes. This rapid charging implies a significant heating of the cells, and this heating needs to be managed.

In the field of motor vehicles, it is known practice to use a thermal regulation device, in particular for cooling, battery packs. Such a thermal regulation device makes it possible to modify the temperature of a battery pack, for example when starting the vehicle in cold weather, by increasing its temperature for example or, whether during driving or during a charging operation, by decreasing the temperature of the cells, which tend to warm up during use.

According to one known solution, the thermal regulation device comprises a cold plate inside which there circulates a cooling fluid, and which is arranged in contact with the cells that are to be cooled. It has been found that such an arrangement can lead to non-uniform cooling of the cells of the one same battery pack that is to be cooled, thus leading to a reduction in the overall performance. Such a thermal regulation device also has a high thermal resistance because of the thicknesses of material present between the cooling fluid and the cells that are to be cooled. In addition, this solution generally has a large overall size.

According to another known thermal regulation solution, a dielectric fluid is atomized and directed, generally in the form of a spray, directly onto the cells, by means of a dielectric-fluid circuit and of dielectric-fluid spray nozzles or orifices. A heat exchange can then take place between the cells and the dielectric fluid which comes into direct contact with a surface of said cells. After the dielectric fluid has been sprayed onto the cells, notably in the liquid phase, the dielectric fluid can flow along the walls of said cells, and accumulate notably in a lower part of the housing receiving the battery pack that is to be thermally regulated. Such a solution is described, for example, in patent document FR3077683. However, notably in the context of use in a vehicle, the cells can not necessarily be laid flat, parallel to the horizontal, but can be inclined, tilted with respect to the horizontal, so that the dielectric fluid can accumulate only on one side. The accumulated dielectric fluid is then not evenly distributed with respect to the cells. These problems can also be encountered when the vehicle is itself inclined, for example on an inclined road, or because of vibrations, due to road conditions, driving, or any other condition. In addition, this can generate greater work for a pump, for example in order to be able to suck up out of the housing the dielectric fluid that has accumulated on one side. In addition, the pump could suck in air, which could damage it.

Patent document FR3060863 proposes another solution for dissipating the heat generated by the battery cells, consisting in installing a spacer between the cells so as to space them apart from each other and in blowing cooling air toward said cells. The solution proposed in that document is, however, relatively complex to produce and does not, in practice, allow uniform and optimal cooling of the cells. It has also been found that the time taken to bring the cells to a desired temperature can be relatively long.

Regulating devices comprising a housing in which a cooling fluid circulates and in which the battery pack is housed are also known. That approach achieves an exchange of heat between the cells and the cooling fluid. However, immersing the cells in a fluid does not allow uniform cooling of said cells.

The invention aims to remedy all or some of the aforementioned drawbacks. In particular, one objective of the invention is to propose a thermal regulation device allowing the cells of a battery pack to be cooled more uniformly and more effectively. Another objective of the invention is to propose a thermal regulation device that makes it possible to bring the cells to the desired temperature more quickly. An additional objective of the invention is to propose a thermal regulation device which is of simple and inexpensive design and which is easy to install.

### SUMMARY OF THE INVENTION

The solution proposed by the invention is a device for the thermal regulation of a vehicle battery pack, comprising:
a housing comprising a circuit for circulating heat-transfer fluid, which housing is suitable for housing a battery pack, which pack comprises at least two battery cells of generally parallelepipedal shape each having two large lateral faces, which cells are adjacent at one of their large lateral faces,
a spacer installed between the cells so as to space them from each other, which spacer is configured to contact the adjacent large lateral faces of said cells.

The spacer comprises:
a perforated part arranged to be situated opposite the large adjacent lateral faces of the cells and to extend over most of said large faces, one or more ribs extending in the perforated part, the rib or ribs being arranged so as to form at least one forced-circulation circuit for the circulation of the heat-transfer fluid between said cells, the forced-circulation circuit comprising an inlet and an outlet.

The proposed innovation consists in now using a special-purpose spacer the particularly simple configuration of which allows the heat-transfer fluid to be forced to circulate along an imposed path. Thus, the forced-circulation circuit for the heat-transfer fluid makes it possible to increase the heat exchange coefficient and ensure uniform cooling or heating over the entirety of the large face of the cells. The cells are therefore brought to the desired temperature very quickly.

Furthermore, because the ribs are in close contact with the large lateral faces of the cells, they are able to contain the swelling thereof and thereby enable an increase in their autonomy and their power.

This spacer ultimately has a threefold function: of keeping the cells apart, of limiting the swelling of the cells, and of creating a circuit for the forced circulation of the heat-transfer fluid.

Further advantageous features of the invention are listed hereinbelow. Each of these features can be considered alone or in combination with the notable features defined hereinabove. Each of these features contributes, as appropriate, to solving specific technical problems defined earlier on in the description, to which problems the other features defined hereinabove do not necessarily contribute. The following features can thus, as appropriate, form the subject matter of one or more divisional patent applications:

According to one embodiment, an inlet of the forced-circulation circuit is located at one edge of a large lateral face and an outlet is located at another edge of said large face.

According to one embodiment, the housing comprises:-a heat-transfer fluid inlet in fluidic communication with the inlet of the forced-circulation circuit of the spacer;-a heat-transfer fluid outlet in fluidic communication with the outlet of the forced-circulation circuit of the spacer.

According to one embodiment, the rib or ribs are arranged in the spacer such that the circulation of the fluid in the forced-circulation circuit takes place only between the inlet and the outlet of said circuit.

According to one embodiment, one or more sealing gaskets are arranged in the space between the adjacent cells such that the circulation of the fluid in the forced-circulation circuit takes place only between the inlet and the outlet of said circuit.

According to one embodiment, the housing is formed by an enclosure which is closed by a cover and a bottom wall such that it is sealed against the ingress/egress of heat-transfer fluid.

According to one embodiment, at least one heat-transfer fluid inlet and at least one heat-transfer fluid outlet of the housing are formed in the bottom wall.

According to one embodiment, the bottom wall is provided with a heat-transfer fluid inlet channel or duct and with a heat-transfer fluid discharge channel or duct; the inlet and the outlet of the forced-circulation circuit open respectively into a first channel or duct and into a second channel or duct formed in the cover; a first duct formed in the housing is configured to convey the fluid circulating in the inlet channel or duct to the first channel or duct; a second duct formed in the housing is configured to convey the fluid circulating in the second channel or duct to the discharge channel or duct.

According to one embodiment, the heat-transfer fluid inlet of the housing is formed in the bottom wall and the heat-transfer fluid outlet of said housing is formed in the cover.

According to one embodiment, the heat-transfer fluid inlet of the housing is formed in the cover and the heat-transfer fluid outlet of said housing is formed in the bottom wall.

According to one embodiment, at least one heat-transfer fluid inlet and at least one heat-transfer fluid outlet of the housing are formed in the cover.

According to one embodiment, the cover is provided with a heat-transfer fluid inlet and/or discharge channel or duct, which channel or duct opens into each spacer.

According to one embodiment, the bottom wall is provided with a heat-transfer fluid inlet and/or discharge channel or duct, which channel or duct opens into each spacer.

According to one embodiment, the bottom wall is provided with a heat-transfer fluid inlet channel or duct, which channel or duct opens into each spacer.

According to one embodiment, the cover is provided with a heat-transfer fluid discharge channel or duct, which channel or duct opens into each spacer.

According to one embodiment, the spacer comprises several ribs arranged in such a way as to form at least a first forced-circulation circuit and a second forced-circulation circuit.

According to one embodiment, the circulation of the heat-transfer fluid in the first circuit and the circulation of said fluid in the second circuit are in the same direction.

According to one embodiment, the circulation of the heat-transfer fluid in the first circuit is in the opposite direction to the circulation of said fluid in the second circuit.

According to one embodiment, the spacer comprises several ribs arranged in such a way as to form at least a first forced-circulation circuit and a second forced-circulation circuit, each forced-circulation circuit comprising a forced-circulation circuit inlet situated at one edge of a large lateral face (100) and an outlet situated at another edge of said large face, the inlets and outlets notably being situated in the cover and in the bottom wall of the housing.

According to one embodiment, the rib or ribs occupy at most 10%, advantageously at most 5% of the surface of a large lateral face of a cell.

According to one embodiment, the spacer is made from a material having a thermal conductivity of at most 0.4W·m⁻¹·K⁻¹, preferably a thermal conductivity of at most 0.2 W·m⁻¹·K⁻¹.

According to one embodiment, the spacer is made from a polymer material or from a polymer-based composite material.

According to one embodiment, the spacer contains a material from the silicate family, preferably being made of fiber-reinforced calcium silicate.

According to one embodiment, the spacer is configured to be clipped onto the first battery cell or bonded to at least one battery cell.

According to one embodiment, when the spacer is bonded on, the spacer is formed of a plurality of independent elements or segments.

According to one embodiment, the spacer is made of a rigid core and of a deformable outer covering which covers at least a portion of said core so as to seal said portion against the ingress/egress of a heat-transfer fluid when this portion is pressing against one and/or the other of the first or second battery cells.

According to one embodiment, the heat-transfer fluid circulation circuit comprises fluid-circulation sections of variable width, these variable-width circulation sections preferably being formed by the spacer.

According to one embodiment, the heat-transfer fluid circulation circuit comprises fluid-circulation sections of decreasing width, the width decreasing, preferably gradually or continuously, from at least one inlet manifold to at least one outlet manifold.

According to one embodiment, turbulators are present in the forced-circulation circuit so as to create turbulence in the flow of the heat-transfer fluid between the inlet and the outlet of said forced-circulation circuit, which turbulators are set in relief and extend in the height of the ribs.

According to one embodiment, the turbulators are formed on one or more supports distinct from the spacer and are added into the forced-circulation circuit.

According to one embodiment, the turbulators and the spacer (3) together form a single-piece entity.

The invention also relates to a cooling system comprising a device according to any one of the foregoing features and further comprising:-a battery pack comprising N adjacent battery cells, including two end cells each arranged at one end wall of the housing, N being a whole number greater than 3; said device comprises at least N−1 spacers, preferably N+1 spacers.

According to one embodiment of the system, one spacer is installed between each cell that is adjacent to another cell; one spacer is installed between each end wall of the housing and the end cell a large lateral face of which is adjacent to said wall; the spacers are in accordance with the invention so that all the large lateral faces of the cells are cooled by a forced-circulation circuit.

According to one embodiment of the system, the heat-transfer fluid is a dielectric cooling fluid.

A further subject of the invention is a motor vehicle equipped with a system according to one of the foregoing features.

### BRIEF DESCRIPTION OF THE DRAWINGS

Further advantages and features of the invention will become better apparent from reading the following description of embodiments, given with reference to the attached drawings, produced by way of nonlimiting indicative examples and in which:

FIG. 1 is an exploded view showing various constituent elements of the device and system according to the invention;

FIG. 2 is a perspective view of a housing;

FIG. 3 is a perspective view of an example of a spacer according to the invention;

FIG. 4 shows an assembly of two adjacent battery cells on which spacers are installed;

FIG. 5 illustrates a view in cross section on A-A of the assembly of FIG. 4;

FIG. 6 illustrates a view in section on B-B of FIG. 2 (the beams not having been depicted);

FIG. 7A, FIG. 7B, FIG. 7C, FIG. 7D, FIG. 7E and FIG. 7F illustrate various possible configurations of the spacer and for the circulation of the fluid;

FIGS. 8A and 8B illustrate one way of circulating the fluid in the housing, said housing being viewed from above and from beneath, respectively.

### DETAILED DESCRIPTION OF THE INVENTION

As used here, and unless indicated to the contrary, any use of the ordinal adjectives “first”, “second”, etc. when describing an object simply indicates that various occurrences of similar objects are mentioned and does not imply that the objects so described need to be in a given sequence, whether in time, in space, in ranking or in any other way. “X and/or Y” means: X alone or Y alone or X+Y. In general, it will be appreciated that, in the various attached figures, the objects have been drawn arbitrarily to make the drawings easier to read.

The thermal-regulation device that forms the subject matter of the invention seeks to regulate the temperature of a battery pack, notably of a battery pack of an electric and/or hybrid motor vehicle. However, it can be fitted to other types of vehicles, or used to regulate the temperature of other electrical and/or electronic components such as power electronics elements, for example, and nonlimitingly, semiconductors, such as diodes or transistors. These could also be components of computer servers. According to one preferred embodiment, the thermal regulation consists in cooling the cells of the battery pack.

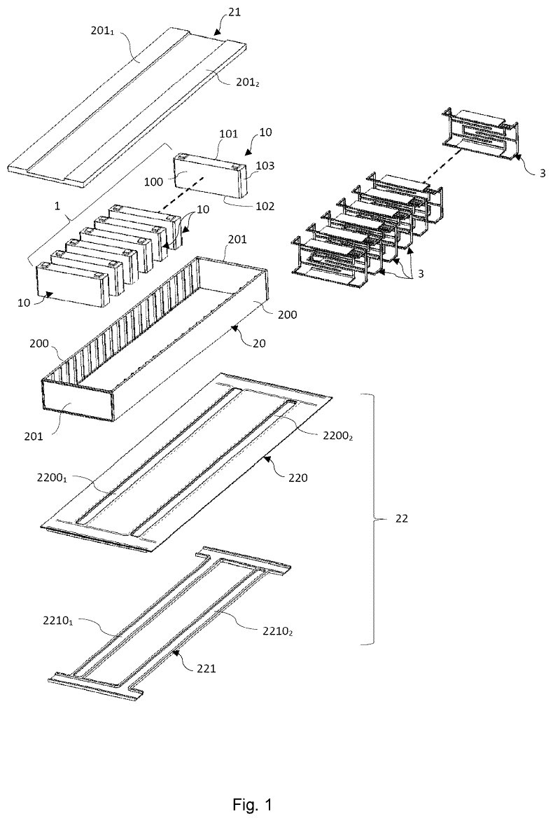

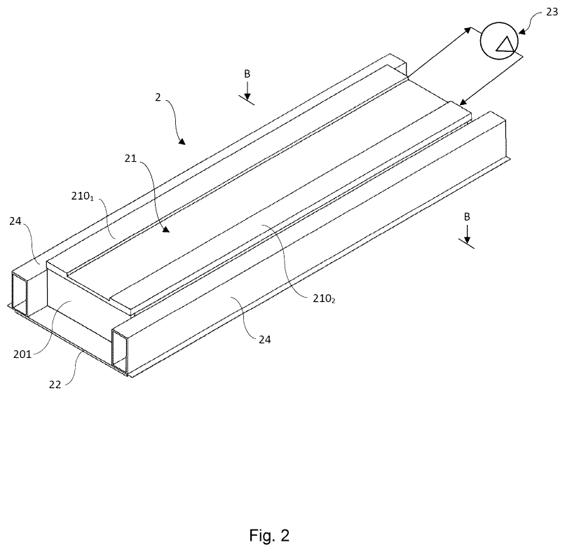

In FIG. 1, the battery pack 1 comprises at least two battery cells 10 and generally between 2 and 25 cells, said pack being housed in a housing 2 (FIG. 2). According to one embodiment, the battery pack 1 comprises N adjacent cells 10, where N is a whole number greater than 2 and preferably greater than 3, including two end cells positioned each at one end wall 201 of the housing 2.

The cells 10 are of the type known to those skilled in the art, generally prismatic, which is to say of parallelepipedal overall shape each having two large lateral faces 100, two small lateral faces 103, a top face 101 and a bottom face 102. These various faces are generally planar but some of them can be curved (dished or bowed). The cells 10 are positioned so they are adjacent at their large lateral faces 100.

The battery pack 1 is housed in a housing 2 formed by an enclosure 20 which is closed by a cover 21 and a bottom wall 22 such that it is sealed against the ingress/egress of heat-transfer fluid. The enclosure 2 has an internal space able to accommodate one or more battery packs. Structural beams 24 can be fixed to the enclosure 20 in order to stiffen the housing 2 further.

In FIG. 2, the housing 2 is of parallelepipedal overall shape, but other suitable shapes can be envisioned, notably according to the overall shape of the battery pack 1. According to one embodiment, the various elements 20, 21, 22 are produced by molding a plastics material, but other materials that suit those skilled in the art can be used.

In the example of FIG. 1, the enclosure 20 is bounded by two lateral walls 200 extending in a longitudinal direction, and two end walls 201 which are perpendicular to said lateral walls.

According to one embodiment, the cover 21 is provided with one or more heat-transfer fluid circulation channels 2101, 2102 in fluidic communication with the enclosure 20. As a preference, these channels 2101, 2102 extend along the entire length of the enclosure 20 so as to be in fluidic communication with all of the cells 10 of the pack 1. These channels 2101, 2102 can act as inlets (namely where the fluid arrives at the housing 2) or outlets (namely where the fluid is discharged from the housing 2). According to one embodiment, one channel 2101 can act as an inlet, and another channel 2102 can act as an outlet. According to another embodiment, the channels 2101, 2102 act as inlets. According to yet another embodiment, the channels 2101, 2102 act as outlets. In another embodiment, the cover 21 has no heat-transfer fluid-circulation channel, the fluid being inlet/outlet exclusively via the bottom wall 22.

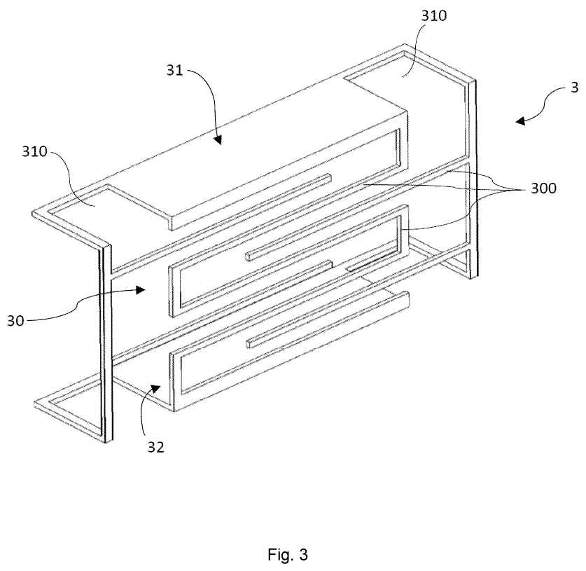

FIG. 3 is a perspective view of an example of a spacer according to the invention.

According to one embodiment, the bottom wall 22 is produced in two parts 220, 221 assembled with one another, for example by screw-fastening, welding, bonding, etc. A first part 22 takes the form of a plate intended to be fixed at the bottom of the enclosure 20. A second part 221 exhibits profile sections in the form of channels 22101, 22102 opening at openings 22001, 22002 formed in the plate 222, which openings are in fluidic communication with the enclosure 20. In FIG. 1, these openings extend along the entire length of the enclosure 20 so as to be in fluidic communication with all of the cells 10 of the pack 1. The channels 22101, 22102 thus open onto each spacer 3 (into each inter-cell space). The bottom wall 22 can, however, be made as a single piece, the channels 2210 then being directly integrated into the plate 220, for example by molding. The bottom wall 22 can form the bottom of the enclosure 20 or can be an attached additional wall independent of the bottom of said enclosure.

The channels 22101, 22102 in the bottom wall 22 are used for the circulation of the heat-transfer fluid 210. They can act as inlets (namely where the fluid arrives at the housing 2) or outlets (namely where the fluid is discharged from the housing 2). According to one embodiment, one channel 22101 can act as an inlet, and another channel 22102 can act as an outlet. According to another embodiment, the channels 22101, 22102 act as inlets. According to yet another embodiment, the channels 22101, 22102 act as outlets. In another embodiment, the bottom wall 22 has no heat-transfer fluid-circulation channel, the fluid being inlet/outlet exclusively via the cover 21.

With reference to FIG. 2, the inlets/outlets of the housing 2 are connected to a heat-transfer fluid circulation circuit 23 comprising, for example, a pumping circuit, notably enabling the heat-transfer fluid to be circulated in said housing in order to regulate the temperature of the cells 10 which are housed therein. The circulation of the fluid in the housing 2 is described in detail later on in the description. The temperature regulation preferably consists in regulated cooling in order to keep the cells 10 at a temperature below or equal to a threshold temperature, for example comprised between 20° C. and 40° C. When the cells 10 exceed this threshold temperature, they are cooled by the heat-transfer fluid, the latter then being a cooling fluid.

In certain instances, for example when starting the vehicle, the regulation can also consist in warming the cells 10, notably when these are at a temperature below or equal to a threshold temperature, for example below 0° C. Below this threshold temperature, the cells 10 are warmed by the heat-transfer fluid, which is then a heating fluid.

The heat-transfer fluid used is preferably a dielectric liquid, for example a mineral oil or fluorinated liquid. The heat-transfer fluid can, however, be in some other form, for example the form of blown air. The fluid can be precooled or preheated according to the thermal regulation intended.

A spacer 3 (or insert, the two terms being synonymous within the meaning of the invention) is installed between each cell 10 that is adjacent to another cell, so as to space these cells apart. A spacer 3 is also advantageously installed between each end wall 201 of the housing 2 and the end cell 10 a large lateral face 100 of which is adjacent to said wall. According to one embodiment, if the battery pack 1 comprises N cells 10, the device comprises at least N−1 spacers 3, preferably N+1 spacers.

Advantageously, the spacers 3 have a relatively low thermal conductivity so as to act as a thermal insulator between the cells. According to one embodiment, the spacers 3 are made from a material having a thermal conductivity of at most 0.4W·m⁻¹·K⁻¹, preferably a thermal conductivity of at most 0.2W·m⁻¹·K⁻¹. The material used can be a polymer or polymer-based composite material, or a material from the silicate family, preferably being made of fiber-reinforced calcium silicate.

Each spacer 3 has a structure configured so that it can be installed removably on a cell 10. According to one embodiment, the structure of the spacer 3 is adjusted (for example by elastically deforming said structure) to suit the shape of the cell 10 so that it can be mounted tightly on said cell so that the contacts between said structure and said cell are contacts that are fluidtight.

In FIGS. 3, 4 and 5, the structure of the space 3 has the overall shape of a U-shaped channel section. The spacer 3 has a first bearing zone 30 configured to come to bear against a large lateral face 100 of the cell 10, a second bearing zone 31 configured to come to bear against the top face 101 of said cell, and a third bearing zone 32 configured to come to bear against the bottom face 102 of said cell. The structure of the spacer 3 can, however, have a different configuration, and for example have only the first bearing zone 30, or only the first zone 30 and the second zone 31, or only the first zone 30 and the third zone 32.

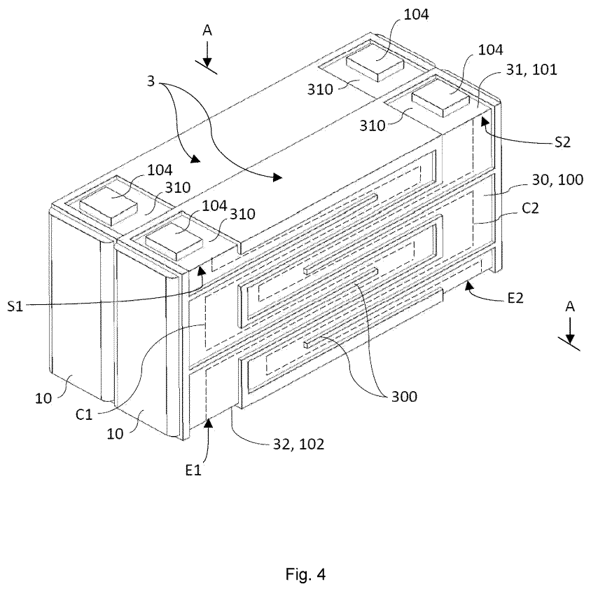

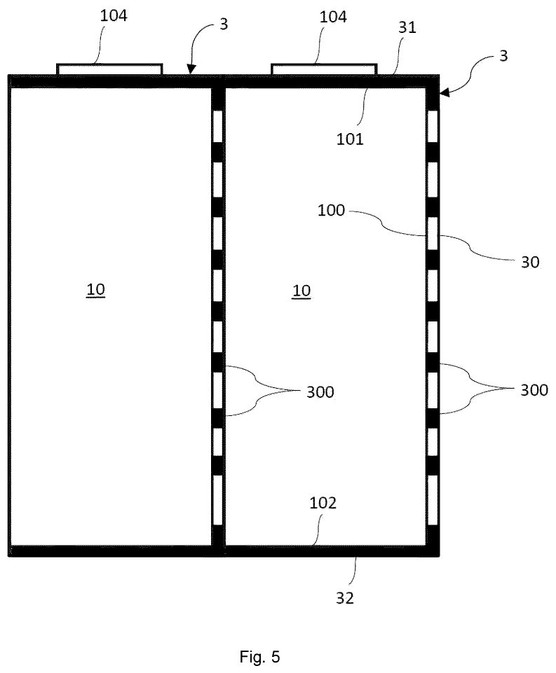

As illustrated in FIGS. 4 and 5, when the cells 10 are installed in the housing 2 in the configuration of use, the first zone 30 comes to bear not only against the large lateral face 100 of the cell 10 against which the space 3 is installed (hereinafter referred to as the “front” large lateral face) but also against the large lateral face 100 of the adjacent cell 10 (hereinafter referred to as the “rear” large lateral face). The first zone 30 is thus sandwiched between the adjacent large lateral faces of the cells. According to one preferred embodiment, the contacts between the first zone 30 and the front and rear large lateral faces of the adjacent cells are contacts that are fluidtight. Alternatively or in addition, one or more sealing gaskets are installed in the space between the adjacent cells 10 so as to create contacts that are fluidtight.

The first zone 30 has the same dimensions, or substantially the same dimensions, in terms of length and width, as those of a large lateral face 100. It has a perforated part situated facing the large lateral face 100 of the cell 10 against which the spacer 3 is installed and which extends over most of said large lateral face. Symmetrically, this perforated part is also situated facing the rear large lateral face of the adjacent cell.

According to one embodiment, the perforated part leaves at least 51%, advantageously at least 90% and preferably at least 95% of the adjacent large lateral faces 100 free. Most of these large lateral faces 100 can thus be in contact with the heat-transfer fluid, as explained further in the description.

One or more ribs 300 extend in the perforated part of the first zone 30 and are arranged so as to form one or more forced-circulation circuits for the circulation of the heat-transfer fluid between the adjacent cells. What is meant by “forced circulation” is that the fluid is forced to follow one or more individual paths imposed by the arrangement of the rib or ribs 300. This or these circuits are thus bounded on the one hand by the adjacent large lateral faces 100 of the cells and on the other hand by the ribs 300. All the large lateral faces 100 of the cells 10 are thus cooled by a forced-circulation circuit. The number of passes (which is to say direction changes in a forced-circulation circuit) is tailored to suit the desired level of heat exchange and/or to suit the permissible pressure drop.

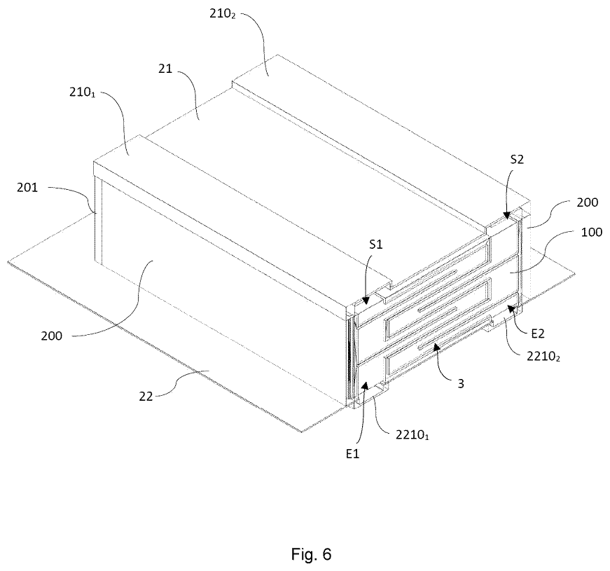

Each forced-circulation circuit comprises a fluid inlet and a fluid outlet, which inlet/outlet are defined by the arrangement of the rib or ribs 300. In the exemplary embodiment of FIGS. 4 and 6, several ribs 300 are arranged in such a way as to form two distinct circuits, C1, C2 respectively, each circuit comprising a respective inlet E1 and E2 and a respective outlet S1 and S2. In other embodiments, the ribs 300 are arranged to form M forced-circulation circuits, where M is a whole number greater than 2.

In the example of FIG. 4, the inlets E1, E2 are situated at one edge of a large lateral face 100 (at the junction where said large lateral face meets the bottom face 102) and the outlets S1, S2 are situated at another edge of said large face (at the junction where said large face meets the top face 101). FIG. 5 illustrates a view in cross section on A-A of the assembly of FIG. 4. Other inlet/outlet configurations are, however, conceivable, notably a configuration that is the inverse of that of FIG. 4. Likewise, the inlets and, respectively, the outlets, are not necessarily situated at the one same edge of the large lateral face 100. An inlet El of a first circuit C1 can be situated at a first edge (for example a top edge) and the outlet S1 at a second edge (for example a bottom edge), whereas the inlet E2 of a second circuit C2 is situated at said second edge and the outlet S2 at said first edge, or vice versa. According to another configuration example, the inlet E1 and the outlet S2 of a first circuit C1 are situated at the one same edge, for example a bottom edge, whereas the inlet E2 and the outlet S2 of a second circuit C2 are situated at another, for example a top edge. In other embodiments, all or some of the inlets/outlets are situated at one or more of the lateral edges of a large lateral face 100 (at the junction where said large lateral face meets a small lateral face 103).

The ribs 300 are preferably straight, but can be curved or have curved portions and rectilinear portions, or can be in the form of broken lines, or any other form that suits the person skilled in the art.

The ribs 300 are in close contact with the adjacent large lateral faces 100. This close contact creates fluidtightness such that the circulation of the fluid in a forced-circulation circuit C1, C2 takes place only between the inlet E1, E2 and the outlet S1, S2 of said circuit. When a plurality of circuits are defined by the spacer 3, there is notably no fluidic communication between these circuits, thus ensuring uniform circulation within each circuit. Alternatively or in addition, one or more sealing gaskets are arranged in the space between the adjacent cells 10 such that the circulation of the fluid in a forced-circulation circuit takes place only between the inlet and the outlet of said circuit.

The thickness of the structure of the spacer 3 and/or the thickness of the ribs 300 is/are dependent on the desired distancing between the cells 10 and/or the desired flow rate for the fluid circulating in the circuit or circuits. The best results, notably in terms of regulation, are obtained when this thickness is comprised between 0.5 mm and 5 mm, advantageously between 1 mm and 4 mm, and preferably between 1.5 mm and 3.5 mm.

In addition to distancing the adjacent cells 10 so that the heat-transfer fluid can flow, the spacers 3 also assume a mechanical role preventing the cells 10 from swelling as a result of their increase in temperature. This because they are able to keep the cells 10 in compression under the effect of this swelling, thereby ensuring that the cells can work to their full capacity.

In order for the ribs 300 to block off a minimal amount of the surface of the large lateral faces 100 that is in contact with the heat-transfer fluid, said ribs occupy at most 10%, advantageously at most 5%, of the surface of a large lateral face 100. Optimum results in terms of the limiting of the swelling and the effectiveness of the exchanges of heat are obtained when the ribs 300 have a width comprised between 0.5 mm and 5 mm, advantageously between 1 mm and 4 mm, and preferably between 1.5 mm and 3.5 mm. The ribs 300 can have the same width or different widths. In particular, the ribs 300 or rib portions situated in the central zone of the large lateral faces 100 can be wider insofar as the mechanical stresses due to the swelling are at their maximum in this zone.

In the attached figures, the second zone 31 and the third zone 32 have the same dimensions, or substantially the same dimensions, in terms of length and width, as those of the top face 101 and bottom face 102 of a cell 10. However, they could have different dimensions in terms of length and/or width. The second zone 31 advantageously has perforated parts 310 designed to leave the connection terminals 104 of the cell 10 free. The third zone 32 can also have perforated parts. In these perforated parts, the fluid is in contact with the top face 101 and lower face 102, contributing to the heat exchanges and to the thermal regulation of the cell 10 at said faces.

When the cells 10 and the spacers 3 are installed in the housing 2 in the configuration of use, the inlet(s)/outlet(s) of the circuit(s) C1, C2 are in fluidic communication with the inlet(s)/outlet(s) of the circuit 23 of the housing 2. In FIG. 6, the openings 22101, 22102 in the bottom wall 22 open onto the inlets E1, E2 and the channels 2101, 2102 of the cover 21 open onto the outlets S1, S2. Thus, the channels 2101, 2102 and 22101, 22102 open onto each spacer 3, which is to say into each inter-cell space.

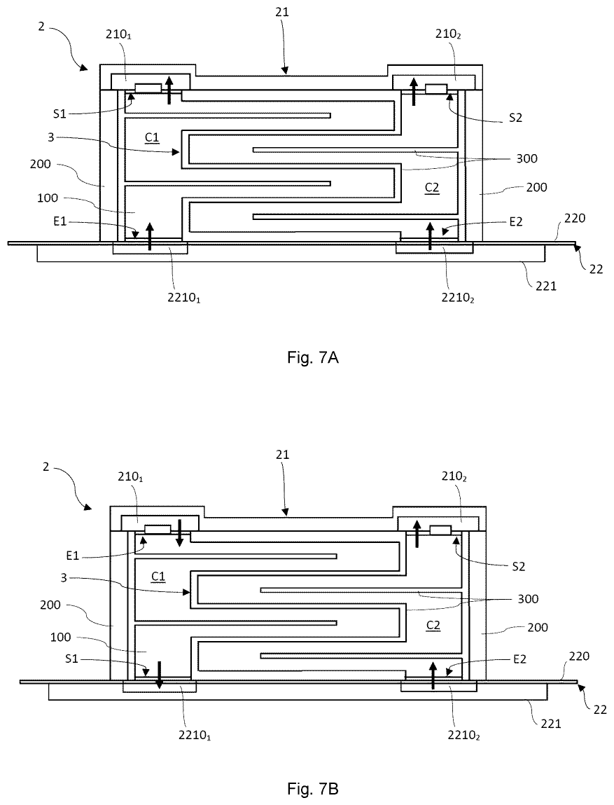

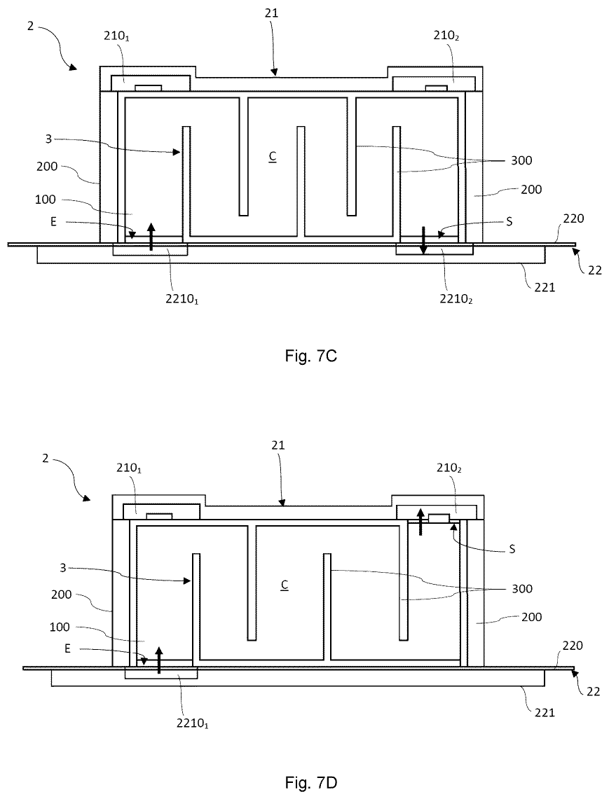

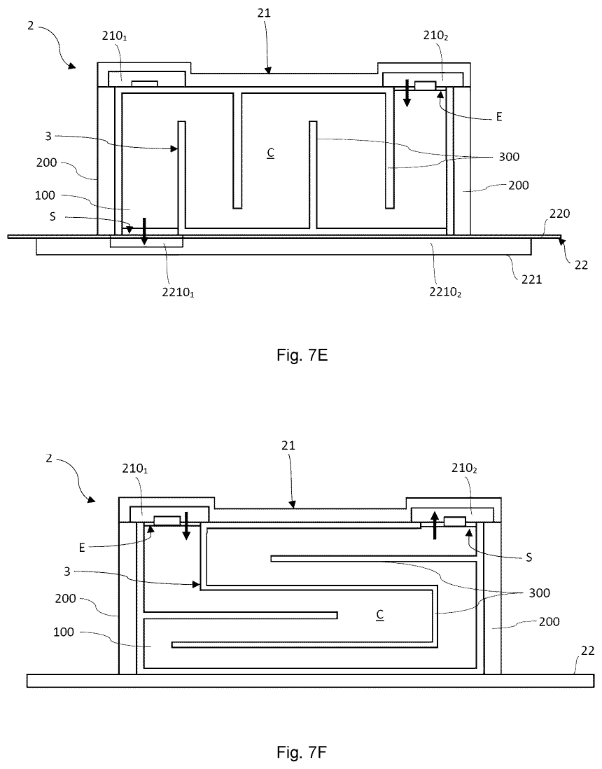

FIGS. 7A, 7B, 7C, 7D, 7E and 7F illustrate various configurations of the device. FIG. 7A corresponds to the abovementioned configuration. The spacer 3 comprises several ribs 300 arranged in such a way as to form a first forced-circulation circuit C1 and a second forced-circulation circuit C2. The first circuit C1 comprises an inlet E1 and an outlet S1 and the second circuit C2 comprises an inlet E2 and an outlet S2. The inlets E1 and E2 are situated at the bottom edge of the large lateral face 100 and the outlets S1, S2 at the top edge of said large face. The inlets E1 and E2 are in fluidic communication with the inlet channels 22101, 22102 formed in the bottom wall 22. The outlets S1 and S2 are in fluidic communication with the discharge channels 2101, 2102 formed in the cover 21. The fluid enters via the inlet channel 22101, is forcibly circulated in the first circuit C1 from the inlet El as far as the outlet S1, and is discharged via the discharge channel 2101. In parallel, the fluid also enters via the other inlet channel 22102, is forcibly circulated in the second circuit C2 from the inlet E2 as far as the outlet S2, and is discharged via the discharge channel 2102. In this instance, the circulation of the fluid in the first circuit C1 and the circulation of said fluid in the second circuit C2 are in the same direction.

The configuration of FIG. 7B is similar to that of FIG. 7A. The main difference is that the inlets E1 and E2 are not situated at the same edge of the large lateral face 100, and neither are the outlets S1, S2. The inlet E1 of the circuit C1 and the outlet S2 of the circuit C2 are situated at the top edge of the large face 100, whereas the inlet E2 of the circuit C2 and the outlet S1 of the circuit C1 are situated at the bottom edge of said large face. In the case of the first circuit C1, the fluid enters via the inlet channel 2101, is forcibly circulated from the inlet El as far as the outlet S1, and is discharged via the discharge channel 22101. In the case of the second circuit C2, the fluid enters via the inlet channel 22102, is forcibly circulated from the inlet E2 as far as the outlet S2, and is discharged via the discharge channel 2102. With this configuration, the circulation of the fluid in the first circuit C1 is in the opposite direction to the circulation of said fluid in the second circuit C2, and this can contribute to improving the exchanges of heat between said fluid and the large lateral faces 100.

In the configuration of FIG. 7C, the ribs 300 are arranged in such a way as to form a single forced-circulation circuit C comprising an inlet E and an outlet S which are both situated at the bottom edge of the large lateral face 100. The fluid in this instance enters and leaves via the bottom wall 22, said fluid not circulating through the cover 21. The fluid enters via the inlet channel 22101, formed in the bottom wall 22, is forcibly circulated in the circuit C from the inlet E as far as the outlet S, and is discharged via the discharge channel 22102 formed in said bottom wall.

The configuration of FIG. 7D is similar to that of FIG. 7C. The main difference is that the inlet E is situated at the bottom edge of the large face 100 whereas the outlet S is situated at the top edge of said large face. The fluid enters via the inlet channel 22101, formed in the bottom wall 22, is forcibly circulated in the circuit C from the inlet E as far as the outlet S, and is discharged via the discharge channel 2102 formed in the cover 21.

A configuration that is the inverse of FIG. 7D can be envisioned, as illustrated in FIG. 7E. In that instance, it is conceivable that the inlet E is situated at the top edge of the large face 100 and the outlet S is situated at the bottom edge of said large face. The fluid enters via the inlet channel 2102, formed in the cover 21, is forcibly circulated in the circuit C from the inlet E as far as the outlet S, and is discharged via the discharge channel 22101 formed in the bottom wall 22.

In the configuration of FIG. 7F, the inlet E and the outlet S of the circuit C are situated at the top edge of the large lateral face 100. The fluid in this instance enters and leaves via the cover 21, said fluid not circulating through the bottom wall 22. The fluid enters via the inlet channel 2101, formed in the cover 21, is forcibly circulated in the circuit C from the inlet E as far as the outlet S, and is discharged via the discharge channel 2102 formed in said cover.

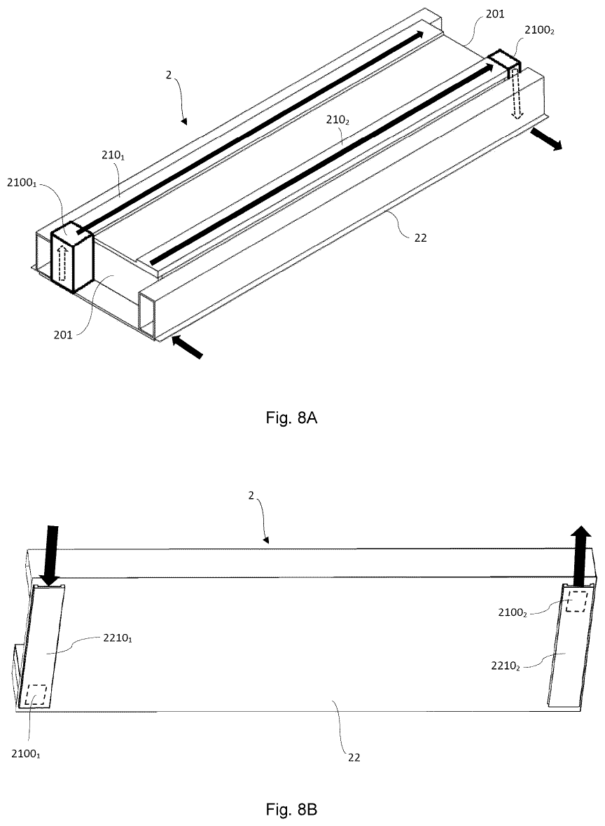

FIGS. 8A and 8B illustrate yet another configuration of the device that can render the assembly particularly compact and easy to install. The configuration of the spacer 3 is similar to that of FIG. 7F insofar as the ribs 300 are arranged in such a way that the inlet E and the outlet S of the circuit C are situated at the top edge of the large lateral face 100. However, the fluid enters and leaves via the bottom wall 22. This wall is provided with an inlet channel 22101 and with a discharge channel 22102, each of which opens onto each spacer 3 (into each inter-cell space). The fluidic connection between the housing 2 and the circuit 23 is therefore solely at the bottom wall 22, thereby simplifying the installation. Furthermore, because the cover 21 has no connections to the circuit 23, it can be removed quickly and easily if the battery pack 1 requires intervention.

FIGS. 8A and 8B illustrate one way of circulating the fluid in the housing, said housing being viewed from above and from beneath, respectively. A first duct 21001 conveys the fluid circulating in the inlet channel 22101 as far as a first channel 2101 formed in the cover 21.

According to one embodiment, the ends of the first duct 21001 open respectively into the inlet channel 22101 and into the first channel 2101. The first duct 21001 thus allows the fluid to be “raised” from the bottom wall 22 as far as the cover 21. The first channel 2101 formed in the cover 21 allows the inlets E of the various circuits C to be supplied in parallel. In FIG. 8A, the first duct 21001 is formed at an end wall 201 of the housing 2.

A second duct 21002 allows the fluid circulating in the second channel 2102 formed in the cover 21 to be conveyed to the discharge channel 22102. According to one embodiment, the ends of the second duct 21002 open respectively into the second channel 2102 and into the discharge channel 22102. The second duct 21002 thus allows the fluid to be “lowered” from the cover 21 as far as the bottom wall 22. The second channel 2102 formed in the cover 21 is in fluidic communication with the outlets S of the various circuits C. In FIG. 8A, the second duct 21002 is formed at another end wall 201 of the housing 2.

In this configuration, the fluid enters via the inlet channel 22101 and passes through the first duct 21001 in order to reach the first channel 2101 of the cover 21. The fluid is therefore forcibly circulated in the circuit C from the inlet E as far as the outlet S. The fluid next circulates in the second channel 2102 and passes along the second duct 21002 to reach the discharge channel 22102 by means of which it is discharged.

The arrangement of the various elements and/or means and/or steps of the invention, in the embodiments described hereinabove, must not be interpreted as demanding such an arrangement in all implementations. In any case, it will be appreciated that various modifications can be made to these elements and/or means and/or steps without departing from the spirit and scope of the invention. In particular, the channels 2101, 2102, 22101, 22102 can take the form of ducts having orifices opening onto each spacer 3 (into each inter-cell space).

Furthermore, one or more of the features set out in just one embodiment can be combined with one or more other features set out in just one other embodiment. Likewise, one or more features set out in just one embodiment can be generalized to the other embodiments, even if this or these features are described only in combination with other features.

What is claimed is:

1. A device for the thermal regulation of a vehicle battery pack, comprising:
a housing including a circuit for circulating heat-transfer fluid, which housing is suitable for housing a battery pack, which pack includes at least two battery cells of generally parallelepipedal shape each having two large lateral faces, which cells are adjacent at one of their large lateral faces,
a spacer installed between the cells so as to space them from each other, which spacer is configured to contact the adjacent large lateral faces of said cells,
wherein the spacer includes:
a perforated part arranged to be situated opposite the large adjacent lateral faces of the cells and to extend over most of said large faces,
one or more ribs extending in the perforated part, the rib or ribs being arranged so as to form at least one forced-circulation circuit for the circulation of the heat-transfer fluid between said cells, the forced-circulation circuit including an inlet and an outlet.

2. The device as claimed in claim 1, wherein an inlet of the forced-circulation circuit is located at one edge of a large lateral face and an outlet is located at another edge of said large face.

3. The device as claimed in claim 1, wherein the housing includes:
a heat-transfer fluid inlet in fluidic communication with the inlet of the forced-circulation circuit of the spacer,
a heat-transfer fluid outlet in fluidic communication with the outlet of the forced-circulation circuit of the spacer.

4. The device as claimed in-one claim 1, wherein the rib or ribs are arranged in the spacer such that the circulation of the fluid in the forced-circulation circuit takes place only between the inlet and the outlet of said circuit.

5. The device as claim 1, wherein the housing is formed by an enclosure which is closed by a cover and a bottom wall such that it is sealed against the ingress/egress of heat-transfer fluid.

6. The device as claimed inclaim 1, wherein the housing includes:
a heat-transfer fluid inlet in fluidic communication with the inlet of the forced-circulation circuit of the spacer,
a heat-transfer fluid outlet in fluidic communication with the outlet of the forced-circulation circuit of the spacer,
wherein the housing is formed by an enclosure which is closed by a cover and a bottom wall such that it is sealed against the ingress/egress of heat-transfer fluid, wherein at least one heat-transfer fluid inlet and at least one heat-transfer fluid outlet of the housing are formed in the bottom wall.

7. The device as claimed in claim 6, wherein:
the bottom wall is provided with a heat-transfer fluid inlet channel or duct and with a heat-transfer fluid discharge channel or duct,
the inlet and the outlet of the forced-circulation circuit open respectively into a first channel or duct and into a second channel or duct formed in the cover,
a first duct formed in the housing is configured to convey the fluid circulating in the inlet channel or duct to the first channel or duct,
a second duct formed in the housing is configured to convey the fluid circulating in the second channel or duct to the discharge channel or duct.

8. The device as claimed in claim 1, wherein the housing includes:
a heat-transfer fluid inlet in fluidic communication with the inlet of the forced-circulation circuit of the spacer,
a heat-transfer fluid outlet in fluidic communication with the outlet of the forced-circulation circuit of the spacer,
wherein the housing is formed by an enclosure which is closed by a cover and a bottom wall such that it is sealed against the ingress/egress of heat-transfer fluid, wherein at least one heat-transfer fluid inlet and at least one heat-transfer fluid outlet of the housing are formed in the cover.

9. The device as claimed in claim 8, wherein the cover is provided with a heat-transfer fluid inlet and/or discharge channel or duct, which channel or duct opens into each spacer.

10. The device as claimed or claim 6, wherein the bottom wall is provided with a heat-transfer fluid inlet and/or discharge channel or duct, which channel or duct opens into each spacer.

11. A cooling system comprising a device for thermal regulation of a vehicle battery pack, including:
a housing including a circuit for circulating heat-transfer fluid, which housing is suitable for housing a battery pack, which pack includes at least two battery cells of generally parallelepipedal shape each having two large lateral faces, which cells are adjacent at one of their large lateral faces,
a spacer installed between the cells so as to space them from each other, which spacer is configured to contact the adjacent large lateral faces of said cells,
wherein the spacer includes:
a perforated part arranged to be situated opposite the large adjacent lateral faces of the cells and to extend over most of said large faces,
one or more ribs extending in the perforated part, the rib or ribs being arranged so as to form at least one forced-circulation circuit for the circulation of the heat-transfer fluid between said cells, the forced-circulation circuit including an inlet and an outlet
the cooling system further comprising:
a battery pack including N adjacent battery cells including two end cells each arranged at one end wall of the housing, N being a whole number greater than 3,
the device comprising-including at least N−1 spacers, preferably N+1 spacers.

12. The cooling system as claimed claim 11, wherein:
one spacer is installed between each cell that is adjacent to another cell,
one spacer is installed between each end wall of the housing and the end cell a large lateral face of which is adjacent to said wall,
the spacers are as claimed in claim 1, such that all the large lateral faces of the cells are cooled by a forced-circulation circuit.

13. The device as claimed in claim 1, wherein the housing includes:
a heat-transfer fluid inlet in fluidic communication with the inlet of the forced-circulation circuit of the spacer,
a heat-transfer fluid outlet in fluidic communication with the outlet of the forced-circulation circuit of the spacer,
wherein the housing is formed by an enclosure which is closed by a cover and a bottom wall such that it is sealed against the ingress/egress of heat-transfer fluid, wherein the cover is provided with a heat-transfer fluid inlet and/or discharge channel or duct, which channel or duct opens into each spacer.

14. The device as claimed in claim 7, wherein the bottom wall is provided with a heat-transfer fluid inlet and/or discharge channel or duct, which channel or duct opens into each spacer.
